(19) United States
(12) Patent Application Publication
(10) Pub. No.: US 2014/0278621 A1
(43) Pub. Date: Sep. 18, 2014

(54) Method for Automatically Configuring a System For Managing Material Handling Assets

(71) Applicant: THE RAYMOND CORPORATION, Greene, NY (US)

(72) Inventors: Steve Medwin, Binghamton, NY (US); Timothy E. Donahue, Binghamton, NY (US); Gregory W. Smiley, Greene, NY (US); Fernando D. Goncalves, Binghamton, NY (US); John B. Kirk, Greene, NY (US)

(73) Assignee: THE RAYMOND CORPORATION, Greene, NY (US)

(21) Appl. No.: 13/827,116

(22) Filed: Mar. 14, 2013

(51) Int. Cl. G06Q 10/06

(52) U.S. Cl. CPC G06Q 10/0631
USPC 705/7.12

(57) ABSTRACT

A facility management computer system is automatically configured when a material handling asset, such as a lift truck, is installed at the facility. A memory stores metadata comprising an asset identification and data specifying characteristics and parameters of the asset that are necessary or desirable in order to enable the facility management computer system to utilize the asset and perform functions, such as assigning work tasks, evaluating asset performance, and scheduling maintenance and repairs, for example. During asset installation the memory is electrically connected to facility management computer system. Upon that connection, the metadata are transferred automatically from the memory into the facility management computer system. Thereafter, the facility management computer system uses the metadata to manage operation of the material handling asset.

### CROSS-REFERENCE TO RELATED APPLICATION

Not applicable.

### STATEMENT CONCERNING FEDERALLY SPONSORED RESEARCH OR DEVELOPMENT

Not applicable.

### BACKGROUND OF THE INVENTION

1. Field of the Invention

The present invention relates to systems and methods for managing assets at a facility, such as a manufacturing plant, a warehouse or a distribution center; and more particularly to configuring a computerized asset management system when a new piece of material handling equipment is added to the facility.

2. Description of the Related Art

Operation of a facility, such as a warehouse, often is controlled by a computer system 2 as depicted in FIG. 1. At the top level is a warehouse management system 3, which is a form of an enterprise resource planning (ERP) system, that serves as an interface between the corporate accounting systems that perform order control, billing, inventory management, and scheduling. The warehouse management system 3 receives customer orders that are to be fulfilled with goods stored in the warehouse. The warehouse management system 3 approves that fulfillment and then provides the customer orders to a warehouse control system 4. The warehouse control system 4 determines how to obtain the ordered goods from storage locations in the warehouse and move those goods to a shipping area. The warehouse control system 4 deploys various assets in the warehouse to fulfill the orders received from the warehouse management system. Thus, depending upon the location and nature of the goods in a customer order, the warehouse control system 4 sends commands to specific pieces of material handling equipment, such as an automated storage and retrieval system 6, a pick to voice system 7 that instructs employees to obtain goods, a conveyor control system 8, and an A-Frame order picking system 9. The warehouse management system 3 and the warehouse control system 4 control similar pieces of the material handling equipment to replenish the inventory of goods in the warehouse. Instead of having a single unified warehouse control system 4, the functionality can be subdivided among separate control systems for each item of the material handling equipment 6-9.

Standard communication protocols have been developed for interfacing the warehouse control system 4 with the material handling equipment 6-9 in order to send data, commands and other messages between those devices. That interface is required to connect material handling equipment to the warehouse control system and assign tasks to that equipment. As a consequence, the management system 3 and the control system 4 had to be configured with the identification of each piece of material handling equipment 6-9 and data defining its characteristics and functionality of each piece in order for that piece of material handling equipment to work with the other components of the computer system 2. Reconfiguring the systems and the communication interfaces occurred each time a new asset, e.g., piece of equipment, that was unknown to control system 4 was installed in the warehouse and the reconfiguring usually had to be done manually by technical personnel performing the installation.

If a change subsequently occurred in the equipment at the facility, such as the removal or upgrade of a particular asset, the control system had to be reconfigured manually. In addition, if a particular asset broke down and thus was unavailable for use, even temporarily, a manual entry of that event and reallocation of remaining assets had to be performed.

Certain material handling assets, such as vehicles like forklifts, reach trucks and pallet trucks, previously were not controlled by the integrated warehouse control system 4. Thus operating data required by that control system had to be transferred manually from each vehicle and entered by hand into the warehouse control system 4. For example, if a particular material handling vehicle had a fault condition, a person had to read the fault code from the vehicle and manually enter it into the control warehouse control system, in order for the control system to have a record of the fault.

Therefore, it is desirable to provide techniques by which a new and unknown material handling asset upon installation is automatically discovered and configured by the asset management system without need for manual human intervention.

### SUMMARY OF THE INVENTION

A method is provided for configuring a facility management computer system when a new material handling asset is installed at the facility. Configuration data, comprising an identification of the material handling asset and at least one physical characteristic of the material handling asset, are stored in a memory. In some instances, the memory is part of the controller on the material handling asset and in other instances the memory may be a separate storage device delivered with the material handling asset.

The memory is operatively connected to the facility management computer system. If the memory is on the material handling asset, that connection may be through a communication network to which the facility management computer system and other equipment at the facility are connected. If the memory is a separate storage device, that device may be connected directly to the facility management computer system. In either case, upon establishing that connection, the configuration data are automatically transferred from the memory into the facility management computer system. Thereafter, the facility management computer system uses the configuration data communicate with, assign tasks to and otherwise manage the operation of the material handling asset.

### BRIEF DESCRIPTION OF THE DRAWINGS

FIG. 1 depicts a computer system for controlling operations of a warehouse;

FIG. 2 is a perspective view of a material handling vehicle that is used in the warehouse;

FIG. 3 is a block diagram of a control system of the material handling vehicle;

FIG. 4 is a computer network that forms an asset management system for the material handling vehicles; and

FIG. 5 graphically depicts a file of configuration data for one type of material handling vehicle.

### DETAILED DESCRIPTION OF THE INVENTION

As used herein, a material handling asset is an apparatus or system related to movement or storage of materials, goods and products throughout manufacturing and distribution processes. Although the present invention is being described in the context of a reach truck, which is a type of material handling vehicle, and use of that vehicle at a warehouse, the present novel configuration method can be applied for other types of material handling vehicles, and in general to mobile and fixed material handling assets found in warehouses, manufacturing plants, warehouses, distribution centers, and other kinds of facilities.

With initial reference to FIG. 2, a reach truck 10, which is a type of material handling asset, includes an operator compartment 11 with an opening 19 for entry and exit by the human operator. Associated with the operator compartment 11 are a control handle 14, a “dead man” floor switch 13, and steering wheel 16. An antenna 75 for wireless communications is mounted on the reach truck 10 and is, as described more fully below, connected to an internal vehicle control system 20 (FIG. 2) to provide bidirectional wireless communications with a remote warehouse management system. It will be apparent to those of skill in the art that the present invention can be used with other types of material handling vehicles, such as pallet trucks, platform trucks, swing reach trucks, counterbalanced fork lift vehicles, orderpickers, stacker/retrieval machines, sideloaders and tow tractors, to name a few examples.

FIG. 3 is a block schematic diagram of a control system 20 for the reach truck 10 and comprises a vehicle controller 21 which is a microcomputer based device that includes memory 24 and input/output circuits. The input/output circuits receive operator signals from the operator control handle 14, the steering wheel 16, a key switch 18, and the floor switch 13. Rotation of the operator control handle 14 in a vertical plane provides a travel request signal to the vehicle controller 21 that indicates a travel direction and speed for the reach truck 10. A four-way switch 15 located on the top of the handle 14 controls a tilt up/down function of the load mast. A plurality of control actuators 41 located on the handle 14 direct a number of additional functions and can include, for example, a reach extend pushbutton, a reach retract pushbutton, and a potentiometer controlling a mast lift function. A number of other vehicle functions also can be provided depending on the construction and intended use of the material handling vehicle.

The vehicle controller 21 responds to those operator input devices by sending output command signals to each of a lift motor control 23 and a propulsion drive system 25 that comprises a traction motor control 27 and a steer motor control 29. The propulsion drive system 25 provides a motive force for propelling the reach truck 10 in a selected direction, while the lift motor control 23 drives load carrying forks 31 along a mast 33 to raise or lower a load 35. The traction motor control 27 drives at least one traction motors 43 which is connected to a propulsion wheel 45 to propel the reach truck along the floor of the facility. The speed and direction of the traction motor 43 and the associated propulsion wheel are designated by the operator via the operator control handle 14, and are monitored and controlled through feedback derived from a rotation sensor 44. For example, the rotation sensor 44 is an encoder coupled to the traction motor 43 and the signal therefrom is used to measure speed and distance that the vehicle travels. The propulsion wheel 45 is also connected to friction brake 22 through the traction motor 43, to provide both a service and parking brake functions for the reach truck 10. The steer motor control 29 is connected to drive a steer motor 47 and an associated steerable wheel 50 in a direction selected by the operator by rotating the steering wheel 16. The direction of rotation of the steerable wheel 50 determines the direction that the reach truck 10 travels.

The lift motor control 23 sends command signals to control a lift motor 51 which is connected to a hydraulic circuit 53 forming a lift assembly for raising and lowering the forks 31 along the mast 33, depending on the direction selected at the control handle 14. The mast 33 on some material handling vehicles can telescope, in which case the hydraulic circuit 53 also raises and lowers the mast. A height sensor 59 is provides a signal to the vehicle controller 21 indicating the height of the forks 31. A weight sensor 57 provides another signal indicating to the vehicle controller 21 whether a load is on the forks 31 and the weight of that load. A load sensor 58 is mounted on the mast to obtain an identification of the goods being transported. The load sensor 58, may be, for example, a radio frequency identification (RFID) tag reader, a Rubee™ device that complies with IEEE standard 1902.1, a bar code reader, or other device capable of reading corresponding identifiers on the goods or the pallet 56 that holds the goods being carried.

The reach truck 10 and vehicle controller 21 are powered by a battery 37 that are electrically coupled to the vehicle controller 21, the traction motor control 27, the steer motor control 29, and the lift motor control 23 through a bank of fuses or circuit breakers in a power distributor 39. Other types of power sources, such as an internal combustion engine or a fuel cell, can be used in place of the battery 37.

In addition to providing control signals to the drive and lift control systems, the vehicle controller 21 furnishes data to an operator display 55 that presents information to the vehicle operator. That information can include vehicle operating parameters, such as for example, the speed of travel, height of the forks 31, battery charge level, temperatures of the motors and other components, hours of operation, time of day, and maintenance needed to be performed. In addition, the display can indicate the weight of the load 35, an identification of the goods being transported, a number of pallets moved during a period of time (e.g. per hour or per work shift), the number of tasks performed, and the like.

Referring still to FIG. 3, the vehicle controller 21 also is connected to several other data input and output devices including, for example, vehicle sensors 66 for parameters such as temperature and battery charge level, a user input device 67, a GPS receiver 68, and a communication port 69. The communication port 69 is connected to a wireless communication device 71, such as a radio frequency transceiver that is coupled an antenna 75, for exchanging data, commands and other messages with a communication system in the warehouse or factory in which the reach truck 10 operates. As an alternative to radio frequencies, wireless communication device 71 may utilize optical, ultrasonic or other forms of wireless signals. Any one of several standard communication protocols, such as Wi-Fi, can be used to exchange messages and data via that communication link. Each reach truck 10 has a unique identifier that enables messages to be specifically communicated to that vehicle. The unique identifier may be the serial number of the reach truck or a unique address on the warehouse communication system. The unique identifier usually is included in every message sent to and from the reach truck 10, however some messages are broadcast to all the reach trucks in the warehouse by using a broadcast identifier to which all vehicles respond.

The vehicle controller memory 24 stores data regarding the operation of the reach truck 10 and the operations performed. That accumulated data, such as that described above as being presented on the operator display 55, are periodically communicated via the wireless communication device 71 to the warehouse management system.

With reference to FIG. 4, the warehouse 100, in which one or more reach trucks 10 and pallet trucks 12 operate, has a communication system 102 that links those e material handling vehicles to a central, computerized warehouse control system 104. The communication system 102 includes a plurality of wireless access points 106 distributed throughout the warehouse 100, such as in a shipping dock and goods storage areas. The wireless access points 106 are radio transceivers connected via a conventional local area network 105 or a TCP/IP communication link to the warehouse control system 104. Alternatively the wireless access points 106 can be wirelessly coupled, such as through a Wi-Fi link, to the warehouse control system. Other material handling assets in the warehouse 100, such a conventional automated storage and retrieval system 108 and a standard conveyor control system 109, are hardwired to the local area network 105. The communication system 102 provides a bidirectional communication link between the material handling assets 10, 12, 108 and 109 and the warehouse control system 104. That communication link enables the warehouse control system to control the operation of those other assets in a well known manner.

The warehouse control system 104 is connected to the warehouse management system 107. The warehouse management system 107 is connected to the Internet 110 for communication with computers and systems outside the warehouse. The Internet connection enables the warehouse management system 107 to access a database 111 that stores manufacturer provided data about the assets located in the warehouse. In addition the warehouse management system 107 is able to exchange information and email via the Internet 110 with a computer system 112 at the headquarters of the warehouse company, a computer system 114 at an asset manufacturer, and a computer system 116 at the local dealer of an asset.

While operating in the warehouse, each reach truck 10 transmits messages operating data through antenna 75 and communication system 102 to the warehouse control system 104, which stores the information. The data can be transmitted continuously while the vehicle is operating, at predefined time periods (e.g., hourly), or at the end of a shift. Information gathered from each vehicle 10, then is relayed occasionally through the Internet 110 to the database 111 and also may be sent to the computer system 114 at the headquarters of the warehouse company.

Because of the bidirectional communications between the vehicle controller 21 and the warehouse communication system 102, the warehouse control system 104 can also send messages and instructions to each reach truck 10. Work assignments can be communicated in that manner to the particular reach truck that is to gather and delivery specific goods. Other messages sent from the warehouse control system 104 contain commands to configure various features and functions on the reach truck 10. In order for those functions to be performed the warehouse control system 104 must know about each material handling asset at the warehouse. Thus a configuration file is stored in the warehouse control system containing a unique identification of and information specifying certain characteristics about each material handling asset with which the warehouse control system is able to interface.

When a new reach truck 10 or other material handling asset that is unknown to the warehouse control system 104 is delivered to the warehouse, the warehouse control system automatically discovers the presence of that asset and is configured to recognize that material handling asset for communication and task assignment purposes. In one implementation, the discovery and configuration process is initiated automatically while a technician is commissioning the reach truck into service. During part of the commissioning process, the reach truck is placed into a configuration mode in which certain data, such as a list of employees authorized to operate the truck, is loaded into the asset control system memory 24. In another part of the commissioning process, the vehicle controller 21 automatically broadcasts an identification message via the wireless communication device 71 and the communication system 102. The identification message contains a unique identifier for the reach truck 10, such as its serial number, and an indication that the reach truck wishes to operate within the warehouse 100. The communication protocol used by the local area network 105 provides for previously unknown assets, such as this reach truck 10, to listen on the radio frequency used by the wireless access points 106 for a quiet message frame in which to send the identification message. Alternatively, the protocol used by the warehouse communication system 102 may have a periodically occurring message frame which is reserved for identification messages from material handling assets. The identification message does not have to contain the network address of the warehouse control system 104, but does contain a indication that it is an identification message.

The software executed by the warehouse control system 104 listens on the network, not only for messages specifically addressed to that system, but also for identification messages. This enable the warehouse control system to discover automatically the presence of a new and unknown material handling asset being installed to the warehouse.

Upon receiving the identification message, the warehouse control system 104 sends a reply message to the identified reach truck 10. The reply message is addressed to the reach truck using its serial number and further contains the network address for the warehouse control system, other information needed to communicate over the local area network 105, and a command for the requesting truck to send its configuration data to the warehouse control system. If the network communication does not use the serial number as the address of the material handling vehicles, the warehouse control system 104 will assign a unique network address to the requesting reach truck 10 for use in sending and receiving future communications over the warehouse communication system 102. The network address will be included in the reply message. Upon the requesting reach truck 10 receiving the reply message, the vehicle controller 21 accesses a table of data stored within the memory 24 and transfers that data to the warehouse control system 104 via the warehouse communication system 102.

As an alternative to a new and unknown material handling asset automatically broadcasts an identification message. The file of data about a reach truck, for example, can be stored on a portable memory device, such as a memory stick or card. During asset commissioning process, the memory device is plugged directly into a port of the warehouse control system. The warehouse control system 104 automatically recognizes the memory device as containing asset identification and configuration data and then transfers that data into a warehouse control system memory without further human intervention.

The configuration data about the material handling asset, in this example a reach truck 10, is referred to as metadata. As used herein “metadata” define the characteristics, parameters, and other information about the material handling asset which are necessary or desirable in order to enable the warehouse control system 104 and the higher level warehouse management system 107 to utilize the asset and perform functions, such as assigning work tasks, evaluating asset performance, and scheduling maintenance and repairs, for example. Much of the metadata are provided by the asset manufacturer, while other metadata item that are unique to use in the warehouse is provided by the warehouse company. The metadata is contained in a file that is both human-readable and machine-readable and has a syntax such as the standard Extensible Markup Language (XML) or a similar defined language which provides a set of rules for encoding a document in another human-readable and machine-readable format. Therefore, the configuration metadata can be easily created and edited by personnel at the asset manufacturer and by a technician installing the asset at the warehouse. By providing the metadata in a markup language that has a predefined syntax, the warehouse control system 104 is able to learn about a new asset data even when the types of metadata vary from manufacturer to manufacturer and asset to asset.

FIG. 5 depicts the syntax of exemplary metadata for the reach truck 10. The exemplary metadata falls into three major sections demarked by the headings “Basic Properties”, “Error Handler”, and “Service Handler”. The Basic Properties category defines characteristics and operating parameters of the vehicle. The Error Handler category specifies how errors that are reported by the reach truck to the warehouse control system 104 can be processed, and the Service Handler category provides information about servicing and maintaining the reach truck asset.

The metadata syntax has each item of data on a separate line that ends with a paragraph return. Each line starts with alphanumeric text specifying the name of the item of data followed by the value of the data in parenthesis to form a data field. For example, the first item is the ID (identifier) for the reach truck 10 that has the value “1234567890”, which is the serial number assigned by the vehicle manufacturer. In certain instances, the data field contains a numerical value followed by units, such as inches, centimeters, pounds, or kilograms. If a data item has multiple values in the data field, adjacent values are separated by a comma, see for example the Max Battery Size. Some data fields, such as those in the Error Handler and the Service Handler sections contain a pointer to an Internet address at which a large amount of information, such as a service manual, is located. In other instances, the data field pointer may be to a company or person's name, telephone number or email address. Those pointers can be used to provide notices from the warehouse control system 104 or the warehouse management system 107 to the specified entity or obtain more information from that entity. It should be understood, however, that other formats for the metadata syntax can be employed, however, it is preferable, but not mandatory, that syntax be both human-readable and machine-readable.

Most of the exemplary items of configuration data are self explanatory, however, a few may benefit from further explanation. The Local ID is a colloquial designation of the asset provided by the warehouse company that operates the asset, for example this reach truck has been named “Suzie”. The Accounting ID is an identifier, such as an asset tag number, that is used by the warehouse company to designate this specific asset on the accounting books of that company. The Accounting ID is not used for material handling assets that are not owned by the warehouse company, for example a leased asset. In that latter case and others where a particular instance of metadata does not apply to the particular asset, there would not be a line in the metadata file for that data item. In other words the associated line in the generic metadata syntax format would be eliminated and not appear at all in the particular configuration data file, as opposed to appearing but having a blank data field. The metadata instance OACH is the height of the reach truck 10 with the mast collapsed to its lowest position. The Reach Depth indicates the maximum distance that the load carrier, e.g., forks 31 can be extended horizontally from the mast 33 under operator control.

With respect to the Error Handler data category, each asset may generate and transmit numerical fault codes designating a particular fault that occurred in the asset. Different asset manufacturers and sometimes different asset models from the same manufacturer have separate definitions of what type of fault is denoted by a given fault code numerical value. Thus, the first data item in the Error Handler section specifies a dictionary from the asset manufacturer that provides a correlation of each numerical fault codes to an alphanumeric description of the corresponding fault condition. The next data items provide information for responding to those faults, such as identifying the operator manual for the asset and contact information a representative of the asset manufacturer.

The Service Handler section of the metadata file provides similar information identifying the service manual for this asset and where it can be obtained, in this example an internet address for the asset manufacture. Contact information is also provided for a local service technician to call for repairing or performing routine maintenance on the material handling asset.

A superset of the metadata profile, containing every possible heading type and instance of data for a material handling asset is maintained by the asset manufacturer and downloadable via the internet by an equipment supplier or system integrator. That entity then can edit down the instances of configuration data to only those required for a particular asset. That edited metadata file then is stored on that asset, e.g., in memory 24 of the reach truck control system 20 for use when commissioning that asset. Equipment suppliers, system integrators, and others may request that the manufacturer of the asset add additional headings, keywords, and data instances to the generic metadata file.

Upon receiving the metadata in the markup language format, the warehouse control system 104 uses the previously received asset identification and configuration data to create an entry for the new material handling asset, e.g., the reach truck 10, in a stored file that lists the warehouse assets. Specifically, the warehouse control system 104 sequentially reads each line in the transmitted metadata file. The warehouse control system 104 identifies the type of data on a line by interpreting the alphanumeric text at the beginning of the line. The information in the data field is extracted and stored in the corresponding location in the configuration data table for this material handling asset that is maintained in a storage device in the warehouse control system 104. In this manner the warehouse control system 104 automatically discovers the presence of a new material handling asset and is configured with the relevant information about the that asset for communication and management purposes.

Thereafter that material handling asset can be deployed into service. When the warehouse control system 104 has a task to assign, such as inserting or removing a pallet of goods on a warehouse shelf, the configuration data for the material handling assets are used by the warehouse control system to determine which assets are capable of performing that task. For example, the Max Load metadata item indicates whether a particular reach truck 10 can carry the weight of the pallet of goods to be transported. The Max Elevated Height metadata item designates whether a particular reach truck can reach the shelf for the pallet of goods. Based on the asset metadata, the warehouse control system 104 assigns the task to a particular reach truck 10.

This process automatically enable the makes the management system to know about all the material handling assets at the facility, and in particular to discovers the presence of a newly installed asset and configured with the relevant information about the that asset for communication and management purposes. Being aware of every available material handling asset and ensures that the warehouse management system can optimally operate the facility. Furthermore, because each asset manufacturer provides its own definition of the Basic Properties and other information that are unique to its particular asset in a markup language format, the present configuration system is independent of manufacturer to manufacturer variation in the configuration data being supplied. Because the markup language format is both human-readable and machine-readable identifies the nature of each data item in a manner that is understood by the warehouse computer system without being programmed to recognize a fixed set of data items.

The foregoing description was primarily directed to a certain embodiments of the reach truck. Although some attention was given to various alternatives, it is anticipated that one skilled in the art will likely realize additional alternatives that are now apparent from the disclosure of these embodiments. Accordingly, the scope of the coverage should be determined from the following claims and not limited by the above disclosure.

1. A method by which a facility management computer system discovers presence of a previously unknown material handling asset upon installation at the facility, said method comprising:
storing configuration data in a memory wherein the configuration data comprise an identification of the material handling asset and information specifying at least one physical characteristic of the material handling asset;
delivering the memory storing configuration data to the facility;
electrically connecting the memory to facility management computer system;
upon connection of the memory to the facility management computer system, automatically transferring the configuration data from the memory into the facility management computer system, and
the facility management computer system using the configuration data to manage operation of the material handling asset.

2. The method as recited in claim 1 wherein the memory is delivered to the facility as part of installation of the material handling asset.

3. The method as recited in claim 2 wherein the memory a separate device from the material handling asset, wherein the memory is adapted to be directly connected to the facility management computer system.

4. The method as recited in claim 1 wherein the memory is incorporated into the material handling asset.

5. The method as recited in claim 4 wherein electrically connecting the memory to facility management computer system comprises the material handling asset establishing a connection to a communication network to which the facility management computer system is connected.

6. The method as recited in claim 4 wherein transferring the configuration data comprises the material handling asset communicating with the facility management computer system.

7. The method as recited in claim 4 wherein transferring the configuration data comprises:
the material handling asset sending a configuration request message to the facility management computer system;
the facility management computer system sending a reply message to the material handling asset; and
the material handling asset responding to the reply message by sending the configuration data to the facility management computer system.

8. The method as recited in claim 4 wherein transferring the configuration data comprises:
the facility management computer system periodically broadcasting a request for asset configuration data; and the
the material handling asset responding to the request by sending the configuration data to the facility management computer system.

9. The method as recited in claim 1 wherein the material handling asset is a material handling vehicle.

10. The method as recited in claim 9 wherein the configuration data specify a load carrying capability of the material handling vehicle.

11. The method as recited in claim 9 wherein the configuration data comprise a height to which the material handling vehicle is able to raise a load.

12. The method as recited in claim 1 wherein the material handling asset produces a fault code, and wherein the configuration data comprise a reference to a document that specifies an operating condition that resulted in production of the fault code.

13. The method as recited in claim 1 wherein the configuration data comprise contact information for an entity that provides maintenance service for the material handling asset.

14. A method for configuring a facility management computer system that contains a file identifying assets at a facility, wherein when a material handling vehicle is installed at the facility the method adds an identification of the material handling vehicle to the file, said method comprising:
storing metadata in a memory on the material handling vehicle, wherein the metadata comprise a vehicle identification and information specifying characteristics of the material handling vehicle;
the material handling vehicle automatically establishing communication with the facility management computer system via a wireless communication link;
upon establishing communication, automatically transferring the metadata from the memory via wireless communication link to the facility management computer system, and
the facility management computer system adding the vehicle identification and information about the material handling vehicle to the file identifying assets at the facility.

15. The method as recited in claim 14 wherein transferring the metadata comprises:
the material handling asset sending a configuration request message to the facility management computer system;
the facility management computer system sending a reply message to the material handling asset; and the
the material handling asset responding to he reply message by sending the metadata to the facility management computer system.

16. The method as recited in claim 14 wherein transferring the metadata comprises:
the facility management computer system periodically broadcasting a request to metadata from any material handling asset; and
the material handling asset responding to the request by sending the metadata to the facility management computer system.

17. The method as recited in claim 14 wherein the metadata specify a load carrying capability of the material handling vehicle.

18. The method as recited in claim 14 wherein the metadata comprise a height to which the material handling vehicle is able to raise a load.

19. The method as recited in claim 14 wherein the material handling vehicle produces a fault code, and wherein the metadata comprises a reference to a document that specifies an operating condition that resulted in production of the fault code.

20. The method as recited in claim 14 wherein the metadata comprise contact information for an entity that provides maintenance service for the material handling asset.
